(19) United States
(12) Patent Application Publication
(10) Pub. No.: US 2005/0232704 A1
(43) Pub. Date: Oct. 20, 2005

(54) Digging roller and rotary type digging apparatus

(75) Inventors: Shoukan Takeda, Osaka (JP); Kouji Okazawa, Osaka (JP); Hiroshi Nakagami, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KOMATSU LTD., Tokyo (JP)

(21) Appl. No.: 11/007,793

(22) Filed: Dec. 9, 2004

(30) Foreign Application Priority Data
Dec. 12, 2003 (JP) 2003-415129

(51) Int. Cl. F16L 1/024

(52) U.S. Cl. 405/156

(57) ABSTRACT

The digging roller is provided with a roller main body rotating around an axis in an approximately horizontal direction, and a plurality of digging bits dotted in an outer peripheral surface of the roller main body. The digging bits have a first arrangement pattern moving the dug soil to an inner side in an axial direction, and a second arrangement pattern moving the dug soil to an outer side in the axial direction. Accordingly, an accumulation portion of the dug soil is dispersed into at least two positions.

### BACKGROUND OF THE INVENTION

1. Field of the Invention

The present invention relates to a digging roller and a rotary type digging apparatus.

2. Description of the Related Art

As the digging apparatus, there are various apparatuses such as a shovel type excavator and the like. Further, a crawler type vehicle for sweeping the mine has been known (for example, refer to Japanese Unexamined Patent Publication No. 7-71898 (FIG. 1)). In this case, a digging roller (drum) is provided. In this case, as a structure provided with the digging roller (drum), a mine disposing and tilling apparatus (for example, Japanese Unexamined Patent Publication No. 2003-42698 (FIG. 1)) has been additionally known.

In this case, the digging roller is provided with a roller main body 51, as shown in FIG. 7. In the drawing, the numeral 52 denotes a single digging bit. And a plurality of (a lot of) digging bits are dotted about a peripheral surface 50 of the roller main body 51, as shown in FIG. 7. At this time, with respect to the digging bits, as shown in FIG. 8 (a brief expansion plan view), there are formed arrangement patterns which are different on the boundary of a center C orthogonal to an axial direction. In other words, the digging bits are provided with a left arrangement pattern 53 in which the digging bits are arranged sequentially in an opposite rotating direction side from a left end portion toward the center C, shown in a left side in FIG. 8, and a right arrangement pattern 54 in which the digging bits are arranged sequentially in the opposite rotating direction side from a right end portion toward the center C, shown in a right side in FIG. 8. In this case, the left arrangement pattern 53 is structured such that the digging bits are arranged at a predetermined pitch along a line approximately in parallel to a line 55 which is inclined at a predetermined angle with respect to an axial direction, and the right arrangement pattern 54 is structured such that the digging bits are arranged at a predetermined pitch along a line approximately in parallel to a line 56 which is inclined at a predetermined angle with respect to the axial direction. In this case, the each digging bit 52 has a base portion 58 risen up from the outer peripheral surface 50 of the roller main body 51, and a bit main body 59 attached to the base portion 58, as shown in FIG. 7.

However, the digging apparatus is provided with a lower traveling body attached to a pedestal frame, and a cab arranged on the pedestal frame, and the digging roller structured as shown in FIG. 7 is arranged in a front side of a pedestal frame. Further, it is possible to dig the ground surface by the each digging bit 52 on the basis of a rotation of the digging roller around an approximately horizontal axis. However, since the digging bits have the arrangement patterns as shown in FIG. 7, if the rotating direction is a direction of an arrow A in FIG. 8 (a direction of scraping out the dug soil in a reverse direction to a forward moving direction of the apparatus), the dug soil is sequentially moved to the center C as shown by arrows B and B, and the dug soil collected in the center C is accumulated in one position in a rear side of the roller and in a front side of the pedestal frame in accordance with the rotation of the roller.

In the case that the dug soil is concentrically accumulated in one position in the rear side of the roller as mentioned above, the dug soil accumulation portion piled on largely is formed, and the accumulation portion prevents the roller from rotating and the digging apparatus provided with the roller mentioned above in the front side from traveling, so that a reduction in a working efficiency is caused.

### SUMMARY OF THE INVENTION

The invention is made for the purpose of solving the conventional disadvantage mentioned above, and an object of the invention is to provide a digging roller and a rotary type digging apparatus which can execute a stable digging work without being affected by the dug soil.

Accordingly, in accordance with a first aspect of the present invention, there is provided a digging roller comprising:
a roller main body 6 rotating around an axis in an approximately horizontal direction; and
a plurality of digging bits dotted in an outer peripheral surface 7 of the roller main body 6,
wherein the digging bits are arranged so as to have a first arrangement pattern 26 moving the dug soil to an inner side in an axial direction, and a second arrangement pattern 27 moving the dug soil to an outer side in the axial direction, and an accumulation portion of the dug soil is dispersed into at least two positions.

In the digging roller in accordance with the first aspect mentioned above, since the digging bits are arranged so as to have the first arrangement pattern 26 moving the dug soil to the inner side in the axial direction, and the second arrangement pattern 27 moving the dug soil to the outer side in the axial direction, and the accumulation portion of the dug soil is dispersed into at least two positions, the accumulation portion of the dug soil is not concentrated on one position, and it is possible to intend to miniaturize the formed accumulation portion. Accordingly, it is possible to avoid the roller rotation from being disturbed by the dug soil, and it is possible to intend to reduce a digging resistance at a time of digging.

In accordance with a second aspect, there is provided a digging roller, wherein the first arrangement pattern 26 is provided in each side of both end portions of the roller main body 6, and the second arrangement pattern 27 is provided in an inner side in the axial direction of each of the first arrangement patterns 26, thereby forming an approximately M-shaped arrangement pattern.

In the digging roller in accordance with the second aspect mentioned above, since the approximately M-shaped arrangement pattern is formed by combining the first arrangement pattern 26 and the second arrangement pattern 27, the accumulation portion of the dug soil can be securely dispersed into two positions, and it is possible to stably avoid the roller rotation from being disturbed by the dug soil.

In accordance with a third aspect, there is provided a rotary type digging apparatus employing the digging roller as recited in the first aspect or the second aspect.

In the rotary type digging apparatus in accordance with the third aspect mentioned above, since the rotary type digging apparatus employs the digging roller as recited in the first aspect or the second aspect, it is possible to avoid the roller rotation from being disturbed by the dug soil, and it is possible to intend to reduce the digging resistance at a time of digging. In particular, in the structure in which the digging roller 5 forms the approximately M-shaped arrangement pattern by combining the first arrangement pattern 26 and the second arrangement pattern 27, it is possible to stably avoid the roller rotation from being disturbed by the dug soil.

In accordance with a fourth aspect, there is provided a rotary type digging apparatus comprising:
a lower traveling body 2 attached to a pedestal frame 1;
a cab 3 arranged on the pedestal frame 1;
a counter weight 4 arranged in a rear side of the pedestal frame 1; and
a digging roller 5 arranged in a front side of the pedestal frame 1,
wherein the digging roller 5 is arranged in a front side of the pedestal frame 1.

In the rotary type digging apparatus in accordance with the fourth aspect mentioned above, it is possible to avoid the rotation and the traveling of the digging roller 5 from being disturbed by the dug soil. In particular, in the structure in which the digging roller 5 forms the approximately M-shaped arrangement pattern by combining the first arrangement pattern 26 and the second arrangement pattern 27, it is possible to stably avoid the traveling from being disturbed by the dug soil.

In accordance with the digging roller on the basis of the first aspect, it is possible to avoid the roller rotation from being disturbed by the dug soil, and it is possible to intend to reduce the digging resistance at a time of digging. Accordingly, it is possible to efficiently execute the stable digging work.

In accordance with the digging roller on the basis of the second aspect, it is possible to stably avoid the roller rotation from being disturbed by the dug soil. Accordingly, it is possible to further efficiently execute the stable digging work. Further, the arrangement pattern of the digging bits is simple, an excellent manufacturing characteristic is obtained, and it is possible to intend to reduce a cost.

In accordance with the rotary type digging apparatus on the basis of the third aspect, it is possible to avoid the roller rotation from being disturbed by the dug soil, and it is possible to intend to reduce the digging resistance at a time of digging. Accordingly, it is possible to obtain the rotary type digging apparatus which can efficiently execute the stable digging work. Further, the arrangement pattern of the digging bits is simple, an excellent manufacturing characteristic is obtained as an entire of the digging apparatus, and it is possible to intend to reduce a cost.

In accordance with the rotary type digging apparatus on the basis of the fourth aspect, it is possible to avoid the rotation and the traveling of the digging roller from being disturbed by the dug soil. Accordingly, it is possible to intend to improve the working efficiency. In particular, in the structure in which the digging roller forms the approximately M-shaped arrangement pattern by combining the first arrangement pattern and the second arrangement pattern, it is possible to stably avoid the traveling from being disturbed by the dug soil. Accordingly, it is possible to further efficiently execute the stable digging work.

### BRIEF DESCRIPTION OF THE DRAWINGS

FIG. 1 is a perspective view showing an embodiment of a rotary type digging apparatus in accordance with the invention;

FIG. 2 is a perspective view of the rotary type digging apparatus;

FIG. 3 is a perspective view of a main portion of the rotary type digging apparatus;

FIG. 4 is a perspective view showing an embodiment of a digging roller in accordance with the invention;

FIG. 5 is a side view of the digging roller;

FIG. 6 is a brief expansion plan view for explaining an arrangement of digging bits of the digging roller;

FIG. 7 is a perspective view of a conventional digging roller; and

FIG. 8 is a brief expansion plan view for explaining an arrangement of the digging bits of the conventional digging roller.

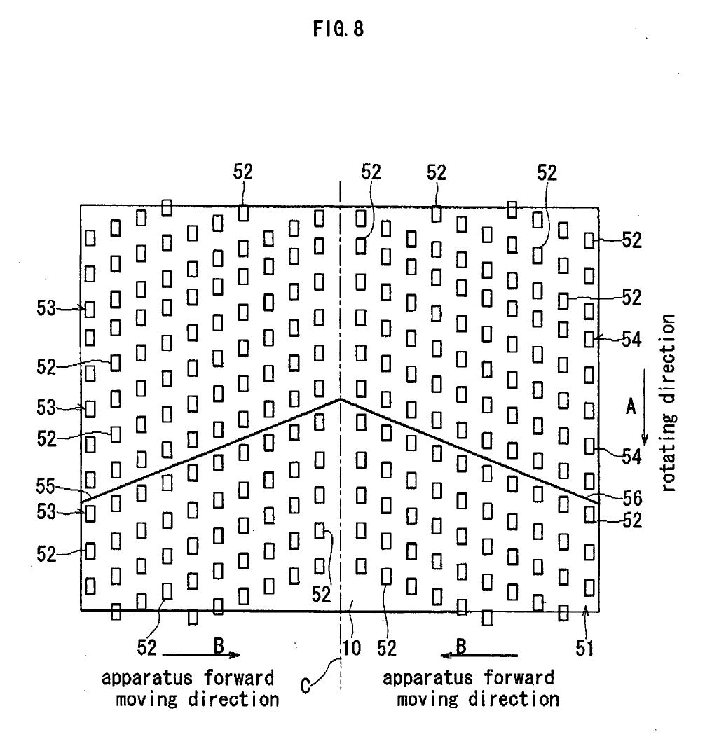

### DESCRIPTION OF THE PREFERRED EMBODIMENT

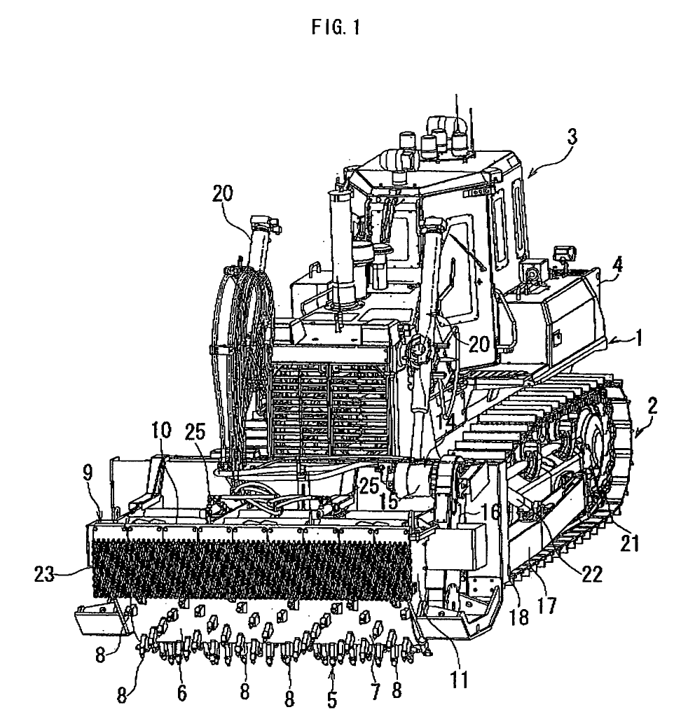

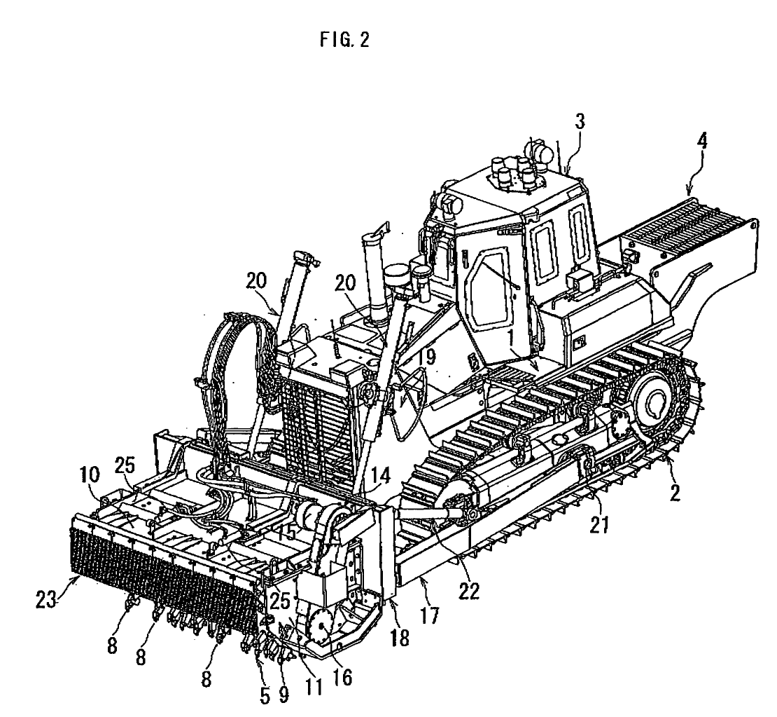

Next, a description will be given in detail of a specific embodiment of a digging roller and a rotary type digging apparatus in accordance with the invention with reference to the accompanying drawings. FIGS. 1 and 2 show perspective views of a rotary type digging apparatus in accordance with the invention. The rotary type digging apparatus is provided with a pedestal frame 1, a lower traveling body 2 attached to a lower side of the pedestal frame 1, a cab 3 arranged on the pedestal frame 1, a counterweight 4 arranged in a rear side of the pedestal frame 1, a digging roller 5 arranged in a front side of the pedestal frame 1, and the like. It is possible to execute the ground surface by rotating the digging roller 5 while traveling forward the rotary type digging apparatus, and it is possible to use, for example, for sweeping the mine. In this case, the lower traveling body 2 is of a crawler type in an illustrated embodiment, however, may be of course constituted by a tire type. Further, taking use for sweeping the mine into consideration, it is preferable that the cab 3 or the like is structured as an explosion-proof specification.

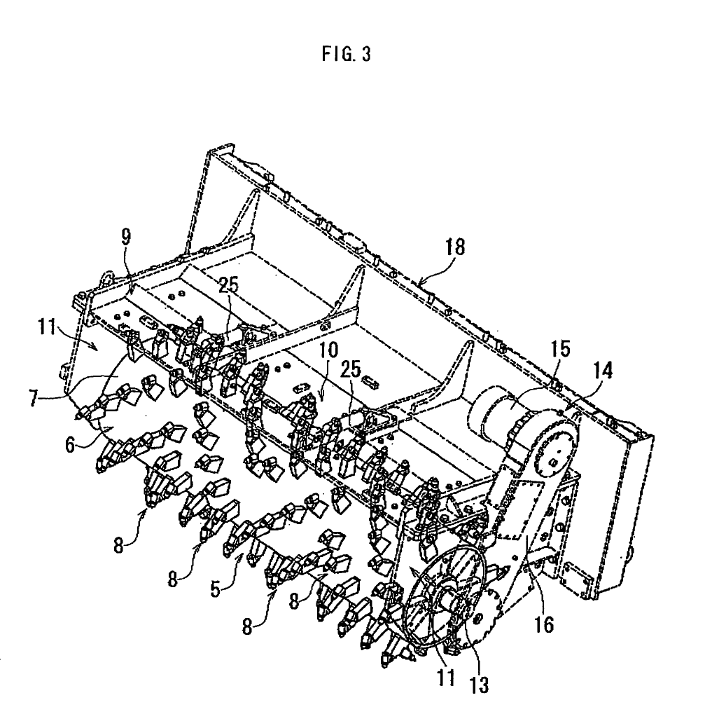

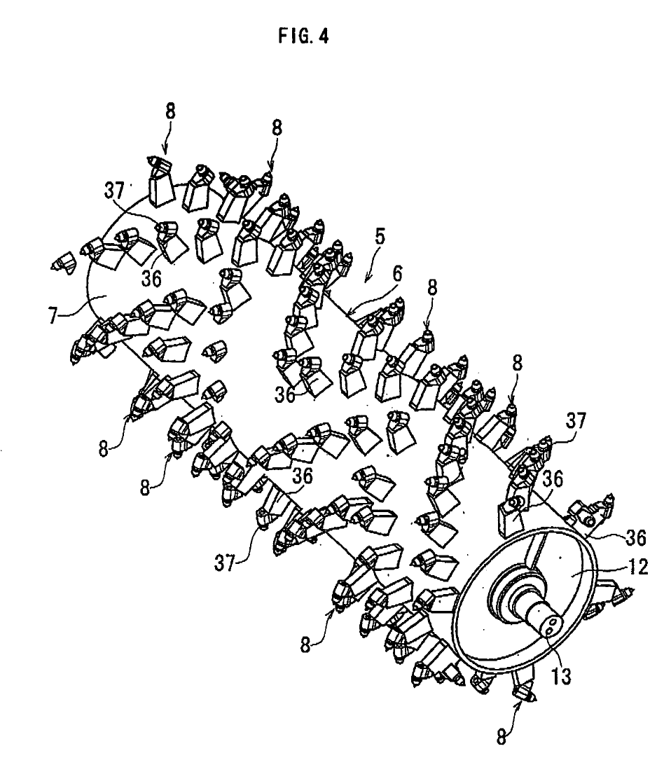

The digging roller 5 is provided with a drum-like roller main body 6, as shown in FIGS. 3 and 4. In the drawings, the numeral 8 denotes a single digging bit. And a plurality of digging bits are dotted in an outer peripheral surface 7 of the roller main body 6, as shown in FIGS. 3 and 4, and the gigging roller 5 is rotatably supported to a support frame body 9 of the pedestal frame 1. In other words, the support frame body 9 is provided with an upper wall portion 10, right and left side wall portions 11 and 11, and a base plate 18 mentioned below. Further, the roller main body 6 is structured such that shaft portions 13 and 13 are protruded from both end surfaces 12 and 12 thereof, and the shaft portions 13 and 13 are rotatably supported to the side walls 11 and 11 of the support frame body 9, respectively. At this time, the digging roller 5 is supported such that a part of the roller main body 6 protrudes slightly to a lower side from a lower opening portion of the support frame body 9, and the ground surface can be dug by the each digging bit 8 on the basis of the rotation of the roller.

Further, as shown in FIGS. 1 to 3, a drive mechanism 14 is connected to one shaft portion 13 of the digging roller, and the digging roller 5 is rotationally driven around an axis in an approximately horizontal direction by driving of the drive mechanism 14. In this case, the drive mechanism 14 is provided with a driving motor (a hydraulic motor) 15, and a transmission member 16 having a belt (not shown) transmitting a rotational drive force of the driving motor 15. In other words, the driving motor 15 is driven, whereby the rotational drive force thereof is transmitted to one shaft portion 13 of the digging roller 5 via the transmission member 16. Accordingly, the digging roller 5 is rotated.

The base plate 18 of the support frame body 9 is supported to a pair of right and left straight frames 17 and 17 extending from the pedestal frame 1. Further, the support frame body 9 can be moved upward and downward around a base end pivot portion 21 of the straight frames 17 and 17 via two lift cylinders 20 and 20 interposed between the base plate 18 and a front portion 19 of the pedestal frame 1. Further, the straight frame 17 and the base plate 18 are connected via an angle cylinder 22 adjusting an angle of the base plate 18. In this case, a cover 23 covering an upper side of a front opening portion of the support frame body 9 is attached to the support frame body 9, and cylinders 25 and 25 for opening and closing the support frame body 9 are attached to an upper wall portion 10 of the support frame body 9.

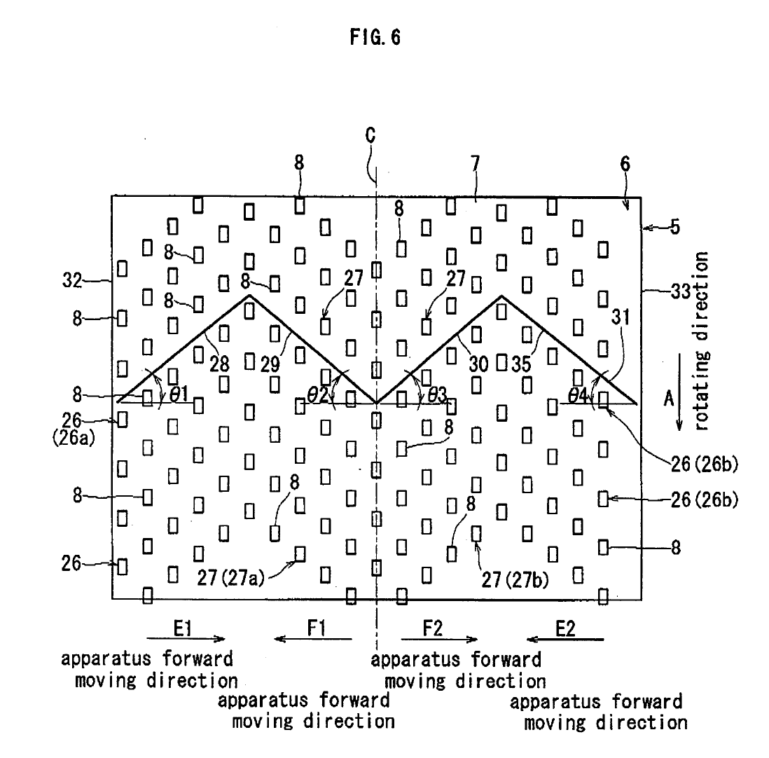

In this case, as shown in FIG. 6, the digging bits of the digging roller 5 are arranged so as to have a first arrangement pattern 26 moving the dug soil to an inner side in an axial direction, and a second arrangement pattern 27 moving the dug soil to an outer side in the axial direction. In this case, an approximately M-shaped arrangement pattern is formed by setting the first arrangement pattern 26 in each of both end portions of the roller main body 6, and setting the second arrangement pattern 27 in an inner side in the axial direction of each of the first arrangement patterns 26. In other words, the first arrangement pattern 26 (26a) in a left side in FIG. 6 is structured by arranging a plurality of the digging bits at a predetermined pitch on a line which is approximately in parallel to a first line 28, the second arrangement pattern 27 (27a) in a left side in FIG. 6 is structured by arranging a plurality of the digging bits at a predetermined pitch on a line which is approximately in parallel to a second line 29, the first arrangement pattern 26 (26b) in a right side in FIG. 6 is structured by arranging a plurality of digging bits at a predetermined pitch on a line which is approximately in parallel to a fourth line 28, and the second arrangement pattern 27 (27b) in a right side in FIG. 6 is structured by arranging a plurality of digging bits at a predetermined pitch on a line which is approximately in parallel to a third line 30.

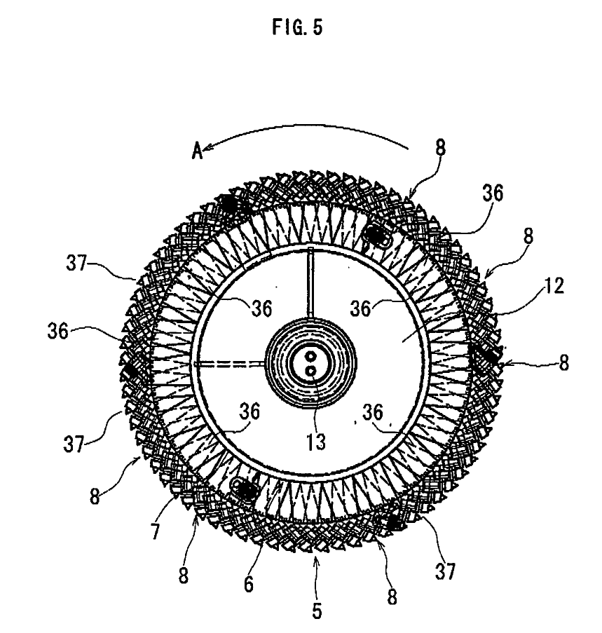

In this case, the first line 28 is inclined at a predetermined angle θ1 (for example, about 40 degree) in an opposite rotating direction from one end edge 32 toward a center C, the second line 29 is inclined at a predetermined angle θ2 (for example, about 40 degree) in the opposite rotating direction from the center C toward the first line 28, the fourth line 31 is inclined at a predetermined angle θ4 (for example, about 40 degree) in the opposite rotating direction from the other end edge 33 toward the center C, and the third line 30 is inclined at a predetermined angle θ3 (for example, about 40 degree) in the opposite rotating direction from the center C toward the fourth line 31. Accordingly, the approximately M-shaped line 35 is formed by the respective lines 28, 29, 30 and 31. In this case, as shown in FIG. 4, the each digging bit 8 has a base portion 36 protruded from the outer peripheral surface 7 of the roller main body 6, and a bit main body 37 attached to the base portion 36. Further, a leading end portion (a digging portion) of the bit main body 37 in each of the digging bit 8 is arranged so as to be directed to a rotating direction of the digging roller (a direction of an arrow A) (refer to FIG. 5). The rotating direction of the roller 5 corresponds to a direction in which the dug soil is scraped in a reverse direction to an apparatus forward moving direction (a forward moving direction).

Accordingly, the each digging bit 8 of the digging roller 5 can dig the ground surface by forward moving the digging apparatus and rotationally driving the digging roller 5. At this time, as shown in FIG. 6, since each of the left side and the right side of the center C is provided with the first arrangement pattern 26 moving the dug soil to the inner side in the axial direction, and the second arrangement pattern 27 moving the dug soil to the outer side in the axial direction, the dug soil is moved toward the center C from one end edge 32 as shown by an arrow E1, and the dug soil is moved toward one end edge 32 from the center C as shown by an arrow F1, in the left side of the center C. Further, in the right side of the center C, the dug soil is moved toward the center C from the other end edge 33 as shown by an arrow E2, and the dug soil is moved toward the other end edge 32 from the center C as shown by an arrow F2. Accordingly, the dug soil is accumulated in two positions between the first arrangement pattern 26a and the second arrangement pattern 27a, and between the first arrangement pattern 26b and the second arrangement pattern 27b.

Further, the dug soil is carried to the rear side (the pedestal frame 1 side) of the digging roller 5 in accordance with the rotation of the digging roller 5, and the accumulated portion of the dug soil is formed between the digging roller 5 and the substrate 18. In this case, since the accumulated portion is dispersed into two sections, the formed accumulated portion is small. Accordingly, the digging work is not disturbed in the formed accumulated portion, it is possible to intend to reduce the digging resistance, and it is possible to stably execute the digging work (the work of forward traveling the digging apparatus while rotationally driving the digging roller 5). In this case, if the digging apparatus is traveled on the ground surface in which the mine is buried, it is possible to dig the ground surface by the digging roller 5, whereby the mine is crushed (destroyed), and is exploded within the support member 9, and it is possible to execute the sweeping process of the mine.

In the digging roller mentioned above, since the each digging bit 8 is arranged so as to have the first arrangement pattern 26 moving the dug soil to the inner side in the axial direction and the second arrangement pattern 27 moving the dug soil to the outer side in the axial direction, and the accumulated portion of the dug soil is dispersed into at least two positions, the accumulated portion of the dug soil is not concentrated into one position, and if the accumulated portion of the dug soil is formed in the rear side of the digging roller 5 (in specific, between the digging roller 5 and the substrate 18), the accumulated portion is small, whereby it is possible to avoid the rotation of the roller from being disturbed by the dug soil, and it is possible to intend to reduce the digging resistance at a time digging. Accordingly, it is possible to efficiently execute the stable digging work. In particular, in the structure in which the digging roller 8 forms the approximately M-shaped arrangement pattern by combining the first arrangement pattern 26 and the second arrangement pattern 27, it is possible to stably avoid the roller rotation from being disturbed by the dug soil. Therefore, it is possible to further effectively execute the stable digging work. Further, the arrangement pattern of the each digging bit 8 is simple and is excellent in the manufacturing characteristic, and it is possible to intend to reduce the cost.

Further, in the digging apparatus mentioned above, since the digging roller 5 mentioned above is used, it is possible to avoid the rotation and the traveling of the digging roller from disturbed by the accumulated portion of the dug soil, and it is possible to intend to improve the working efficiency. In particular, in the structure in which the digging roller 5 forms the approximately M-shaped arrangement pattern by combining the first arrangement pattern 26 and the second arrangement pattern 27, it is possible to stably avoid the traveling from being disturbed by the dug soil. Accordingly, it is possible to further efficiently execute the stable digging work.

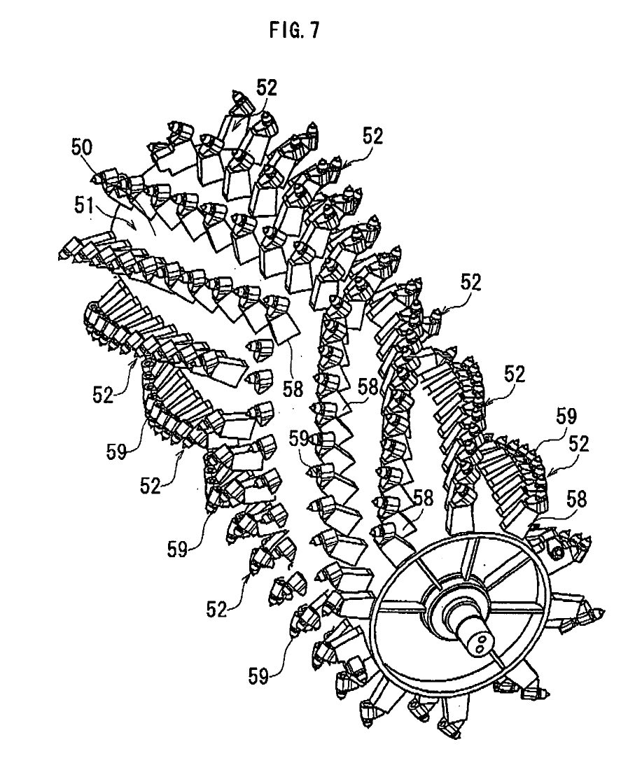

In this case, comparing the structure using the digging roller in which the arrangement pattern of the digging bit 52 is formed in an approximately V-shape as shown in FIG. 7 mentioned above, with the structure using the digging roller in which the arrangement pattern of the digging bit 8 is formed in the approximately M-shape as shown in FIG. 3 mentioned above, in the case of such a work having no great load that the dug soil is constituted by a decomposed granite soil (in the case of a normal load), a difference in the working efficiency is not too much. However, in the case of such a work having a great load that the dug soil is constituted by a pea gravel, a pudding stone contained sandy soil or the like, a vehicle speed is increased in the structure using the digging roller in which the arrangement pattern is formed in the approximately M-shape, and an improvement of the working efficiency can be intended. In specific, in the pudding stone contained sandy soil, the vehicle speed comes to 1.65 times, and in the pea gravel, the vehicle speed comes to 1.45 times.

The description is given above of the specific embodiment of the invention, however, the invention is not limited to the embodiment mentioned above, and can be variously modified within the scope of the invention. For example, the arrangement pitch in the peripheral direction of the digging bit 8 and the arrangement pitch in the axial direction thereof can be optionally set within the range in which the accumulated dug soil is not concentrated to one position, in correspondence to the nature of the dug soil, the outer diameter of the digging roller 5, the size in the axial direction of the roller, the rotating speed of the roller, the traveling speed of the apparatus and the like. At this time, for example, in comparison with the structure in which the arrangement pattern of the digging bit is formed in the approximately V-shape as shown in FIG. 7 mentioned above, the structure can be made such that a total number of the used bit is reduced, however the number of the bit arranged in the same peripheral direction is increased. Accordingly, it is possible to reduce the digging resistance and it is possible to improve the digging performance. Further, it is possible to change the magnitude and the inclined angle of the bit main body 37 of the digging bit 8, and the inclined angles θ1, θ2, θ3 and θ4 of the lines 28, 29, 30 and 31 structuring the arrangement patterns 26 and 27, in correspondence to the various conditions mentioned above such as the nature of the dug soil and the like. Further, in the embodiment mentioned above, as shown in FIG. 6, the second arrangement pattern 27a in the left side and the second arrangement pattern 27b in the right side are continuously formed, however, the second arrangement pattern 27a in the left side and the second arrangement pattern 27b in the right side may be shifted with respect to the rotating direction. Further, in the embodiment mentioned above, the accumulated portion of the dug soil is dispersed into two positions, however, may be dispersed into three or more positions. In this case, it is preferable to increase the combination of the opposing first arrangement pattern 26 and second arrangement pattern 27. Since the formed accumulated portion becomes extremely small by increasing the number of dispersion, there can be obtained an advantage that a further improvement of the working efficiency can be achieved. In this case, since the rotary type digging apparatus can dig the surface of the ground surface, the rotary type digging apparatus is not limited to the use for sweeping the mine.

1. A digging roller comprising:
a roller main body rotating around an axis in an approximately horizontal direction; and
a plurality of digging bits dotted in an outer peripheral surface of the roller main body
wherein the digging bits are arranged so as to have a first arrangement pattern moving the dug soil to an inner side in an axial direction, and a second arrangement pattern moving the dug soil to an outer side in the axial direction.

2. A digging roller as claimed in claim 1, wherein said first arrangement pattern is provided in each side of both end portions of the roller main body, and the second arrangement pattern is provided in an inner side in the axial direction of each of the first arrangement patterns, thereby forming an approximately M-shaped arrangement pattern.

3. A rotary type digging apparatus employing the digging roller as claimed in claim 1 or 2.

4. A rotary type digging apparatus as claimed in claim 3 comprising:
a lower traveling body attached to a pedestal frame;
a cab arranged on the pedestal frame; and
a counter weight arranged in a rear side of the pedestal frame
wherein a digging roller is arranged in a front side of the pedestal frame.
